(19) United States
(12) Patent Application Publication
(10) Pub. No.: US 2001/0034611 A1
(43) Pub. Date: Oct. 25, 2001

(54) Electronic audit system and electronic audit method

(76) Inventors: Kazuo Ooya, Tokyo (JP); Yasuhiro Fukui, Tokyo (JP)

Correspondence Address: SUGHURE, MION, ZINN, MACPEAK & SEAS, 2100 Pennsylvania Avenue, N.W., Washington, DC, 20037-3202, US

(21) Appl. No.: 09/837,487

(22) Filed: Apr. 19, 2001

(30) Foreign Application Priority Data
Apr. 21, 2000 (JP) P2000-121419

(51) Int. Cl. G06F 17/60

(52) U.S. Cl. 705/1; 705/35

(57) ABSTRACT

An audit system is provided, capable for auditor of performing a preliminary audit of an ISO compliant management system via a network or the like, without actually going to the system site, and offers an enhanced audit content and a shorter audit period by subsequently performing an efficient site audit. The audit system accesses a electronic system for audit via a communication device such as the Internet, audits the system for examination based on the required information sent from the system for examination, and then based on these results performs an efficient site audit.

### BACKGROUND OF THE INVENTION

1. Field of the Invention

The present invention relates to an electronic audit (e-check) system and an electronic audit method for auditing an ISO (International Organization for Standardization) compliant management system (for development, manufacturing, or the environment and the like).

2. Description of the Related Art

Conventionally, an audit of an ISO compliant management system (for development, manufacturing, the environment and the like) by an audit organization has involved an auditor visiting the company of the customer using the system for audit, and conducting the audit by sampling information from enormous volumes of stored records within a limited time period.

In the conventional audit of an ISO compliant management system described above, there are occasions when a high quality audit cannot be performed due to factors such as the time taken for the auditor to reach the audits site, and the effort and time required to perform the audit while confirming records at the site.

Furthermore, the company involved in maintaining and managing the system for audit needs to make staff available during the audit period, meaning the customer undergoing the audit has also borne a considerable load.

Moreover, within the audit organization, staff need to be dispatched every time an audit occurs, and as the number of customers undergoing audit increases, the number of auditors actually in-house decreases, and so education for improving the skills and abilities of auditors is extremely difficult to schedule, which proves an impediment to improving the abilities of auditors.

The present invention has been designed to resolve the conventional problems described above, with an object of providing an electronic audit system and an electronic audit method in which an auditor is able to perform a preliminary audit of an ISO compliant management system via a network or the like without actually going to the system site, and by subsequently performing an efficient site audit is able to offer enhanced audit content and a shorter audit period.

### SUMMARY OF THE INVENTION

In order to achieve the above object, a first aspect of the present invention comprises an electronic test object system, an electronic audit system, and a communication device for providing a line connection between the audit system and the test object system, wherein the audit system and the test object system connect via the communication device, and the audit system audits the test object system based on necessary information sent from the test object system.

A second aspect of the present invention comprises a electronic test object system, a electronic audit system, a maintenance management device for maintaining and managing the test object system, a configuration transmission device for transmitting configuration information of the test object system to the audit system, an identification information transmission device for transmitting an ID and a password to the audit system, an audit sequence determination device for determining an audit sequence and creating a sequence chart showing the audit sequence, an access device for accessing the test object system using an ID and a password received via the identification information transmission device, an audit device for auditing the test object system accessed via the access device in accordance with the sequence chart, and recording results, a display device for displaying audit results obtained by audit with the audit device, and a judgement device for judging the quality of the audit results based on the audit results displayed by the display device.

A third aspect of the present invention is an audit sequence determined by the aforementioned audit sequence determination device, which incorporates a site audit performed by an auditor visiting the site.

An aforementioned judgement device of a fourth aspect of the present invention judges the operating status quality of the system for audit based on audit items, audit content and audit results displayed by the display device, and records such operating status quality in an audit results recording chart.

A fifth aspect of the present invention is an aforementioned test object system in which an original of a regulation document and a procedure document defining the system activity are managed electronically, and record documents for recording activity comprise records managed electronically and records managed on paper, and for those records managed on paper, a management status thereof is computerized.

An aforementioned maintenance management device of a sixth aspect of the present invention, monitors variations in external environment, and when a variation occurs, reflects such variation in the test object system.

A seventh aspect of the present invention comprises the steps of constructing a system for audit, maintaining and managing the system for audit, receiving configuration information of the system for audit, determining an audit sequence for the system for audit, receiving an audit ID and password and connecting to the system for audit, and performing an audit of the system for audit in accordance with the determined audit sequence.

An eighth aspect of the present invention further comprises the steps of displaying audit results for the system for audit and judging the quality of the audit results based on the displayed audit results.

In the present invention, an audit organization is able to perform a periodic audit of the operating status of an electronically constructed ISO (International Organization for Standardization) compliant management system (for development, manufacturing, or the environment and the like) via the Internet or the like, from inside or outside the organization using the system for audit. Such an audit could be realized using the following procedure for example. The ISO compliant management system is constructed electronically. During the construction process, a general purpose groupware product (such as StarOffice, Exchange, GroupMax, TeamWare or Explorer) is used, and the regulations and records which require managing are managed in a form (electronic management or paper management) which matches the characteristics of the object medium (so that items which can be managed electronically are managed as electronic data, whereas for items which are more efficiently managed on paper only the management status is managed electronically). An audit ID (with a restricted time limit and restricted access) and a password are supplied to the audit organization, and the audit organization then uses the supplied ID and password to access the system and perform a preliminary audit of those records identified as preliminary audit items. During this preliminary audit, in those cases where questions need to be asked of managerial staff, or the content of documents or records is unclear, video conferencing or audio conferencing can be used, so that the audit proceeds with both parties having access to the same content. A site audit is then performed based on the results of the preliminary audit.

### BRIEF DESCRIPTION OF THE DRAWINGS

FIG. 1 is a block diagram showing a sample configuration of an electronic audit system of the present invention.

FIG. 2 is a block diagram showing a sample processing flow for the audit device shown in FIG. 1.

FIG. 3 is a diagram showing a sample format of the audit results recording chart shown in FIG. 1.

FIG. 4 is a block diagram showing a sample configuration of the system for audit shown in FIG. 1.

FIG. 5 is a block diagram showing a sample configuration of the system for audit maintenance and management device shown in FIG. 1.

FIG. 6 is a diagram showing a sample configuration of the system for audit configuration transmission device shown in FIG. 1.

FIG. 7 is a block diagram showing a sample configuration of the audit ID and password transmission device shown in FIG. 1.

FIG. 8 is a diagram showing a sample format of the audit procedure storage chart shown in FIG. 1.

FIG. 9 is a diagram showing a sample configuration of the audit results display device 9.

FIG. 10 is a block diagram showing a sample processing flow for the audit results judgement device shown in FIG. 1.

FIG. 11 is a block diagram showing a sample processing flow for the audit sequence determination chart shown in FIG. 1.

FIG. 12 is a block diagram showing a sample processing flow for the audit sequence determination device shown in FIG. 1.

FIG. 13 is a flowchart showing an embodiment of an electronic audit method of the present invention.

### DETAILED DESCRIPTION OF THE INVENTION

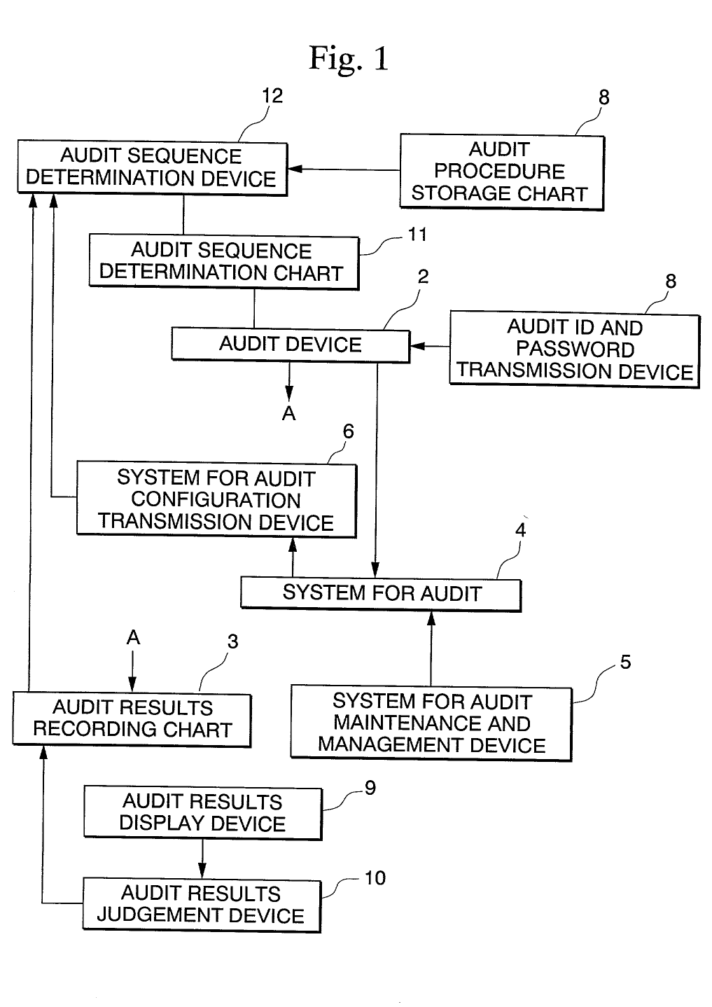

Hereinafter, a preferred embodiment of the present invention is described with reference to the attached drawings. FIG. 1 is a block diagram showing a sample configuration for an electronic audit system of the present invention. The electronic audit system comprises an audit device 2, an audit results recording chart 3, a system for audit 4, a system for audit maintenance and management device 5, a system for audit configuration transmission device 6, an audit ID and password transmission device 7, an audit sequence storage chart 8, an audit results display device 9, an audit results judgement device 10, an audit sequence determination chart 11, and an audit sequence determination device 12.

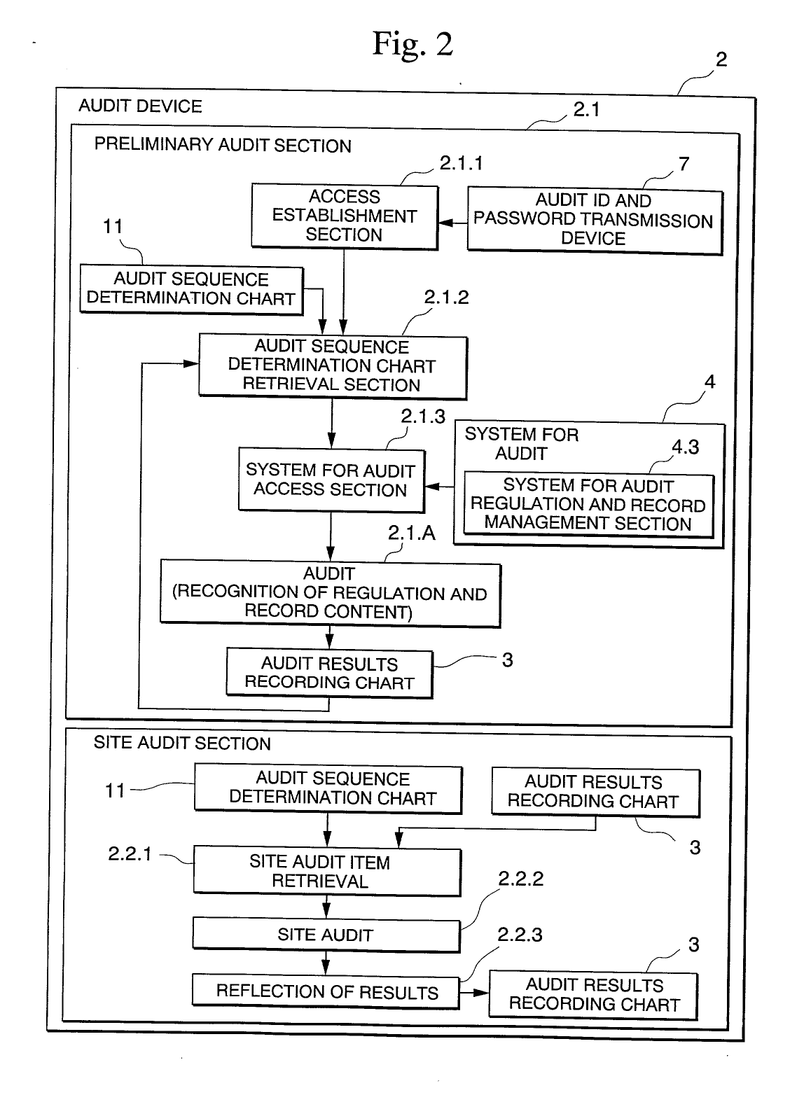

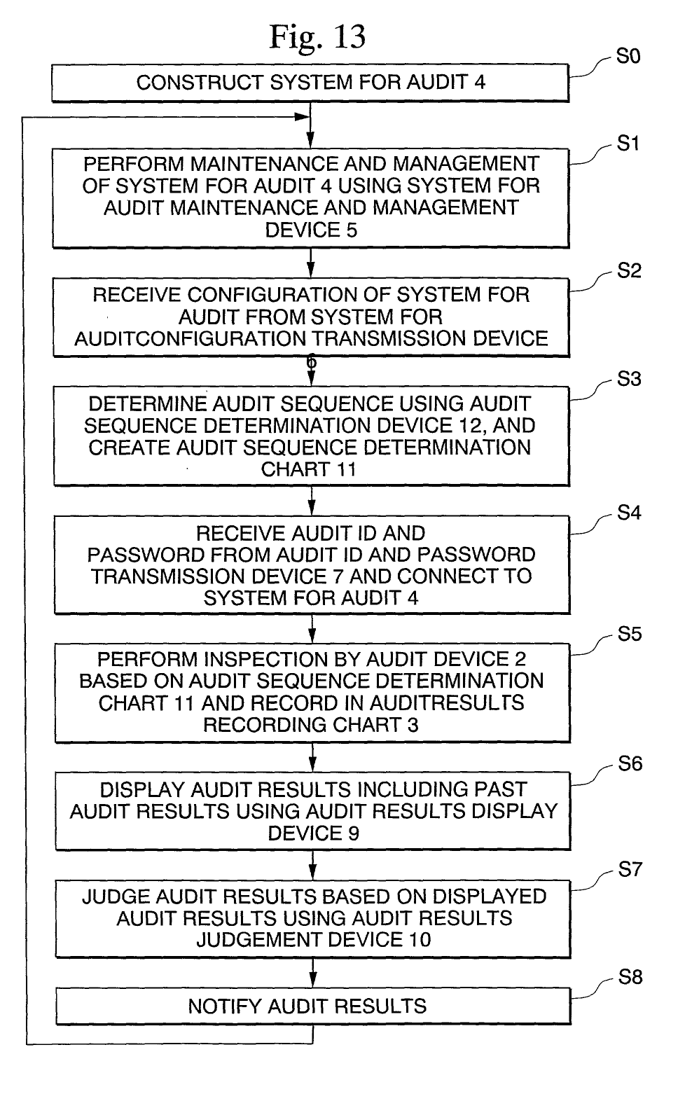

Next is a more detailed description of each of the devices and charts described above. The audit device 2 has a processing flow sequence such as that shown in FIG. 2. The box 2.1 shows the processing flow for a preliminary audit section, and the box 2.2 shows the processing flow for an actual site audit section. For example, by using an audit ID and password received from the audit ID and password transmission device 7 of the preliminary audit section, access is established with the system for audit 4 (2.1.1), the content of the system for audit 4 is judged (2.13) in accordance with instructions from the audit sequence determination chart 11 (2.12), and the results produced are recorded (2.13) in the audit results recording chart 3. The site audit section of 2.2 is described in more detail with reference to step S5 of FIG. 13.

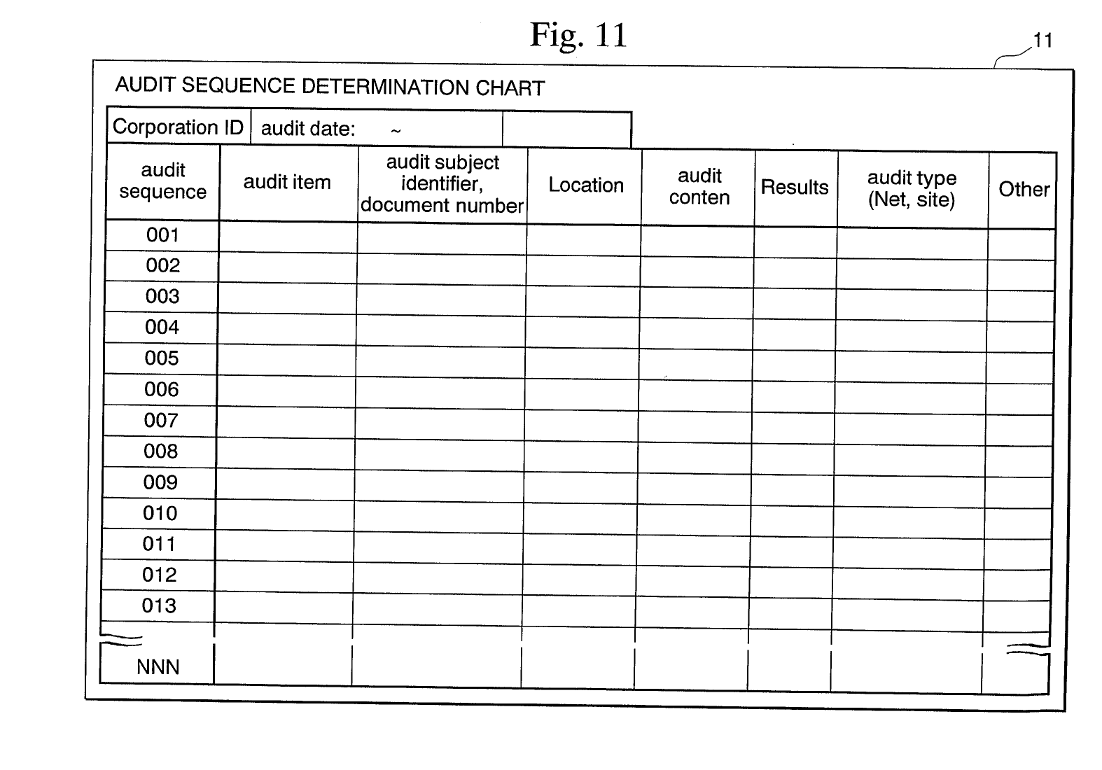

The audit sequence determination chart 11 is shown in FIG. 11, and comprises, for each corporation ID, scheduled audit date, and audit item assigned by the audit organization for management purposes, categories for displaying an audit sequence showing the audit sequence, an identifier for the audit object and an identifying document number, a location showing the place where the document with the identifying document number is stored, audit content relating to the audit item, audit results, an audit type distinguishing those audits performed via a network and those audits performed on site, and an “other” category.

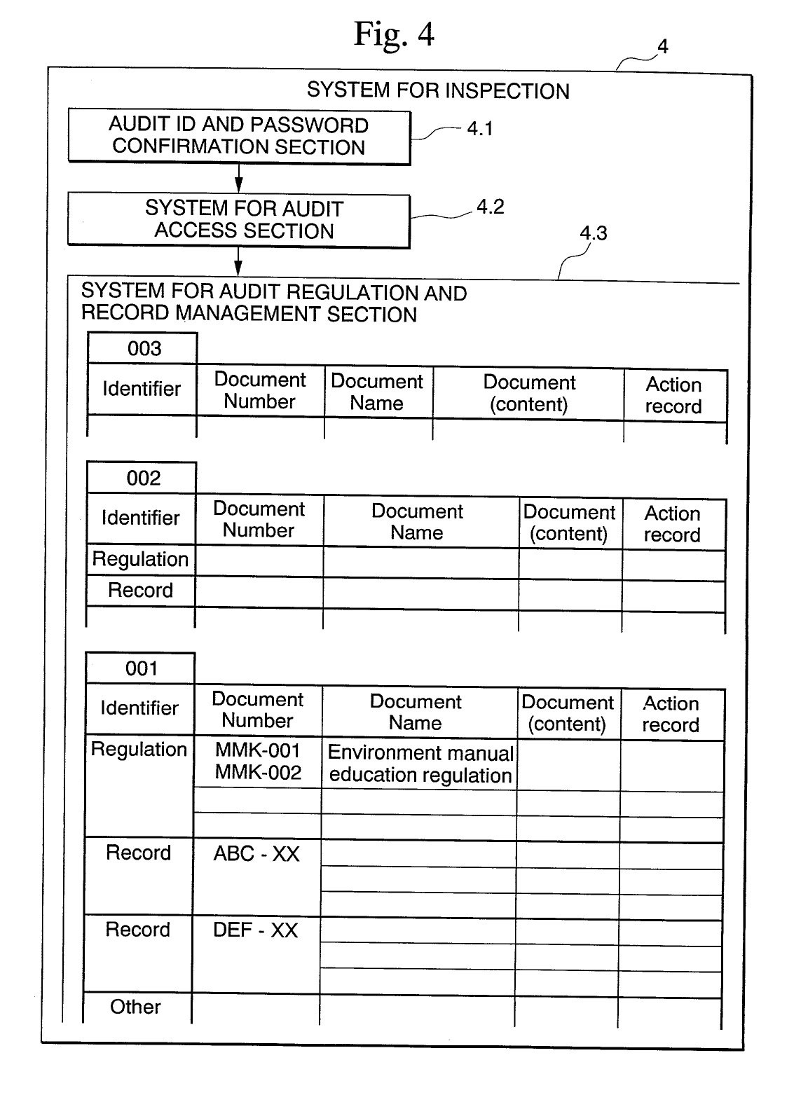

The system for audit 4, as shown in FIG. 4, comprises an audit ID and password confirmation section 4.1 for confirming an audit ID and password, a system for audit access section 4.2 for retrieving information managed a system for audit regulation and record management section 4.3 in accordance with instructions from the audit device 2, and a system for audit regulation and record management section 4.3 for managing past action (operation) records relating to regulations, records and other record entities (such as document numbers and document names of identifiers, regulations and records, content of regulations and records).

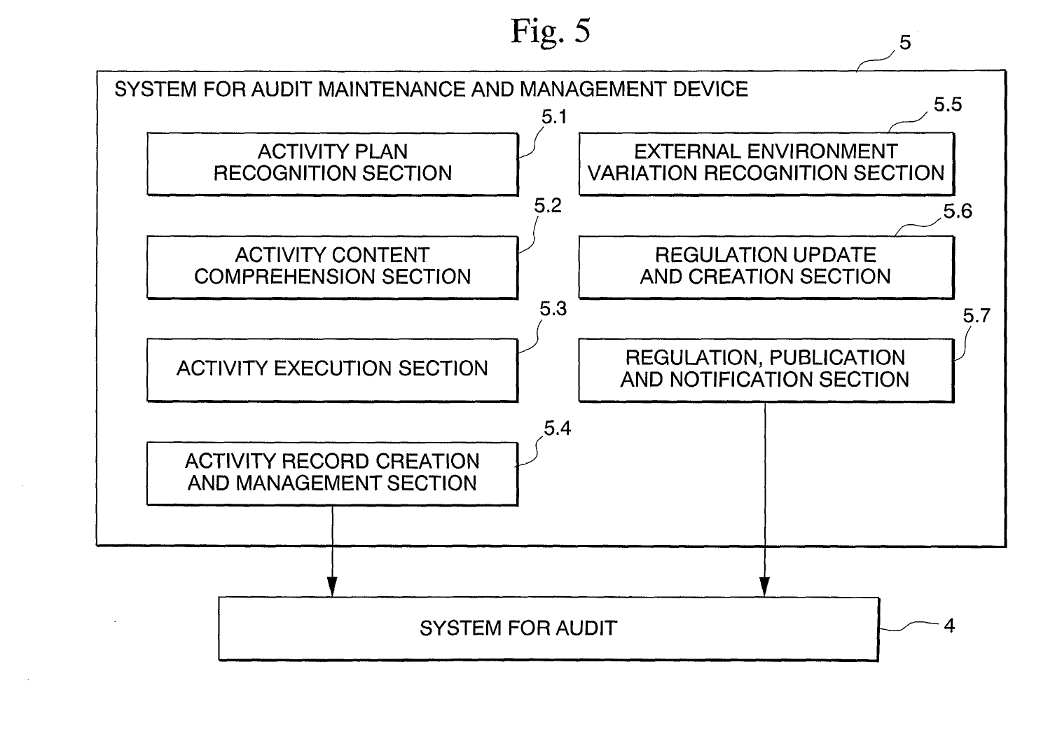

The system for audit maintenance and management device 5 is as shown in FIG. 5, and comprises an external environment variation recognition section 5.5, a regulation update and creation section 5.6 for reflecting any variations in the external environment in the regulation and procedure documents as well as creating new regulation and procedure documents, a regulation, publication and notification section 5.7 for publishing updated regulation and procedure documents and newly created regulation and procedure documents as well as issuing notification of such publications, an activity plan recognition section 5.1 for drafting a yearly activity plan based on the content laid out in the regulations, an activity content comprehension section 5.2 for comprehending the drafted activity content and breaking such content down into specific execution plans, an activity execution section 5.3 for executing the specified activities, and an activity record creation and management section 5.4 for recording the results of activities and registering such results in the system for audit 4.

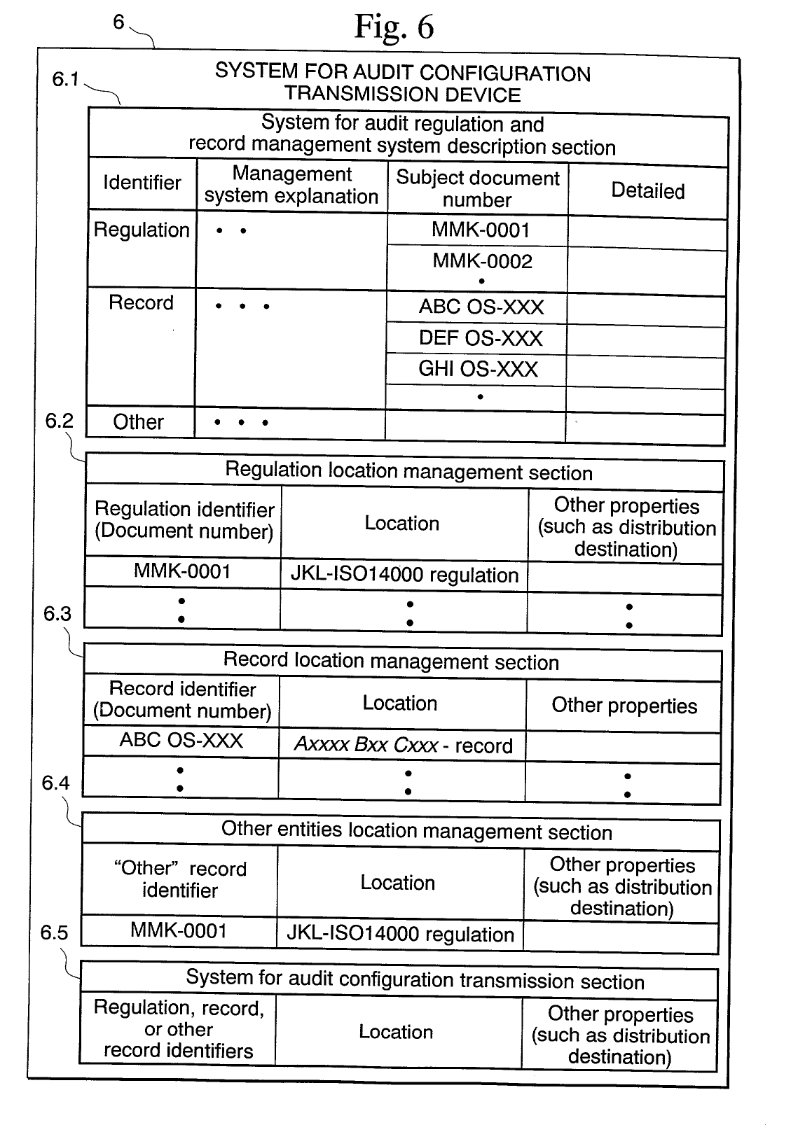

As shown in FIG. 6, the system for audit configuration transmission device 6 comprises items for expressing the structure of the system for audit 4 (refer to FIG. 4) such as “Identifier (regulation, record)”, “Management System Explanation” for showing whether the regulation or record indicated by the identifier is managed entirely electronically, or alternatively whether only the management status is managed electronically due to the item being unsuited to electronic management, “Object Document Number” for specifying the regulation, record or entity being managed, as well as items for describing the regulation or record.

The system for audit configuration transmission device 6 comprises a system for audit regulation and record management system description section 6.1, a regulation location management section 6.2 with a “Location” category for showing the location of an identifier “Regulation” within the system for audit, and an “Other Properties” category for showing associated information relating to the regulation (such as a distribution record showing a distribution destination, for example), a record location management section 6.3 with a “Location” category for showing the location of an identifier “Record” within the system for audit 4 (refer to FIG. 4), and an “Other Properties” category for showing associated information relating to the record (such as a distribution record showing a distribution destination, for example), an other entities location management section 6.4 with a “Location” category for showing the location of an identifier “Other” within the system for audit 4 (refer to FIG. 4), and an “Other Properties” category for showing associated information relating to the “Other” entity (such as a distribution record showing a distribution destination, for example), and a system for audit configuration transmission section 6.5 for transmitting this type of construction information relating to the system for audit.

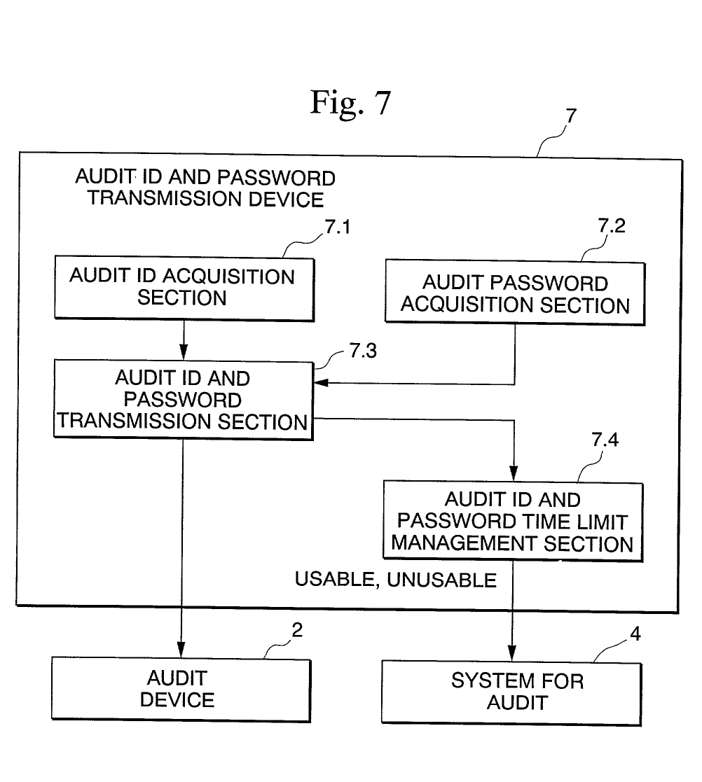

The audit ID and password transmission device 7, as shown in FIG. 7, comprises an audit ID acquisition section 7.1 for acquiring an ID for the audit, an audit password acquisition section 7.2 for acquiring a password to be used with an audit ID, a password transmission section 7.3 for transmitting an audit ID and password to a third party organization carrying out the audit, and a password time limit management section 7.4 for managing an ID and password time limit and notifying the system for audit 4 whether or not a particular audit ID and password are able to be used.

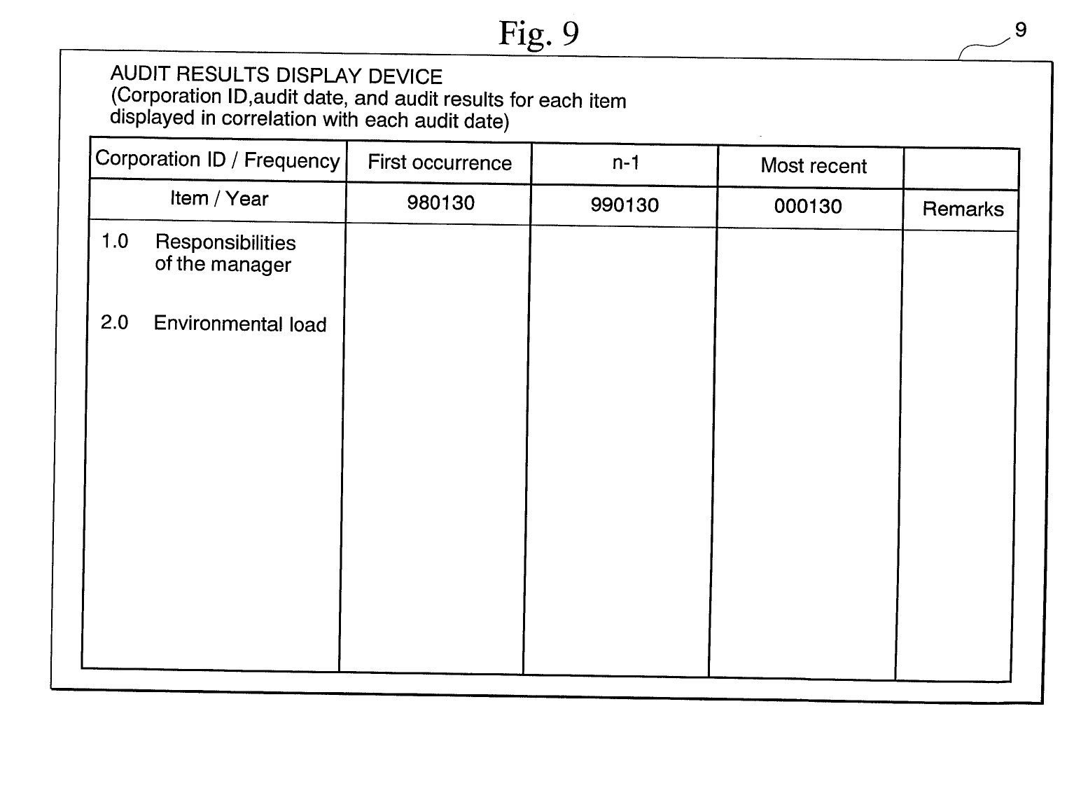

The audit results display device 9 displays the contents of the audit results recording chart 3 chronologically for each audit item, as shown in FIG. 9.

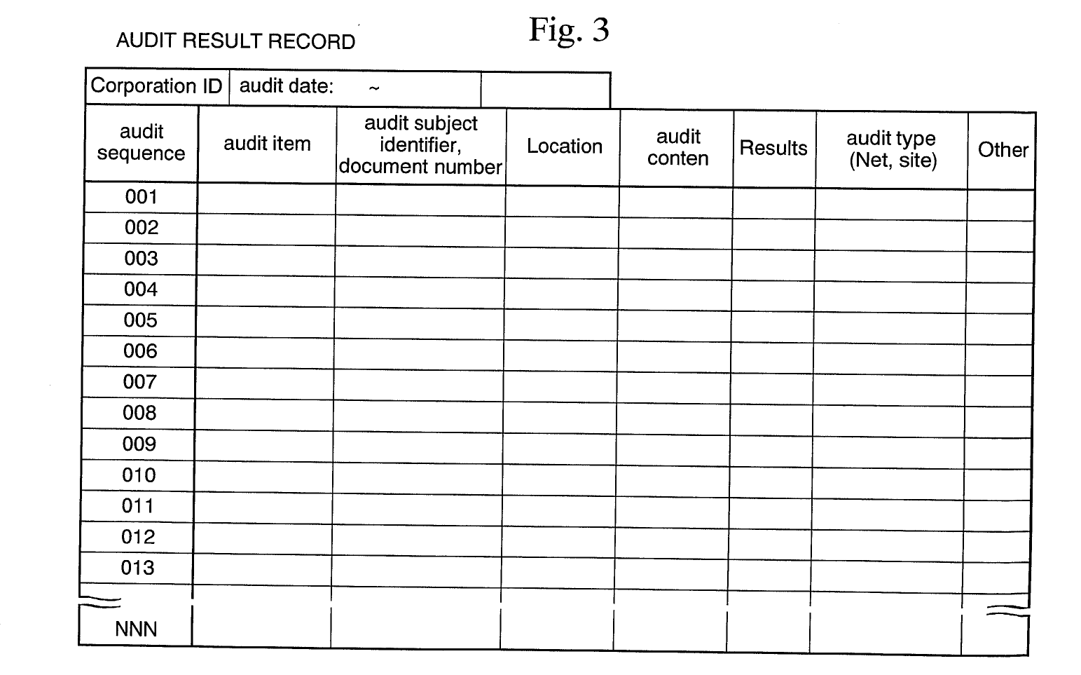

As shown in FIG. 3, the audit results recording chart 3 comprises, for each corporation ID, audit date, and audit item assigned by the audit organization for management purposes, categories for displaying an audit sequence showing the audit sequence, an identifier for the audit object and an identifying document number, a location showing the place where the document with the identifying document number is stored, audit content relating to the audit item, audit results, an audit type distinguishing those audits performed via a network and those audits performed on site, and an “other” category. The records of past audits are all stored under the corresponding corporation ID.

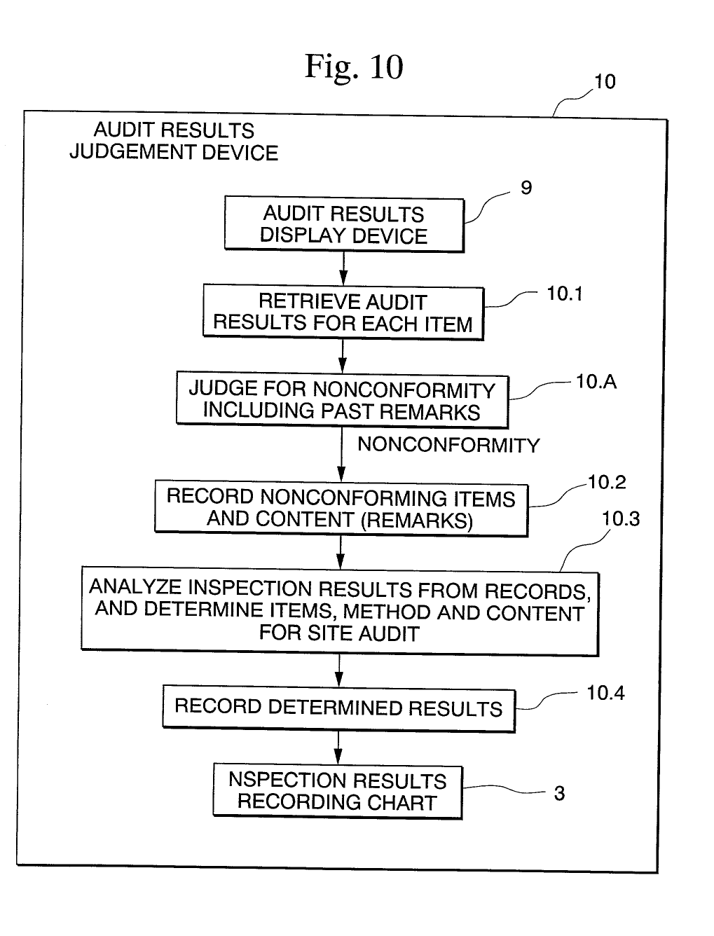

As shown in FIG. 10, the audit results judgement device 10 judges the results of the current audit based on the content displayed by the audit results display device 9, records the audit results in the audit results recording chart 3, and also notifies the organization who requested the audit of the audit results.

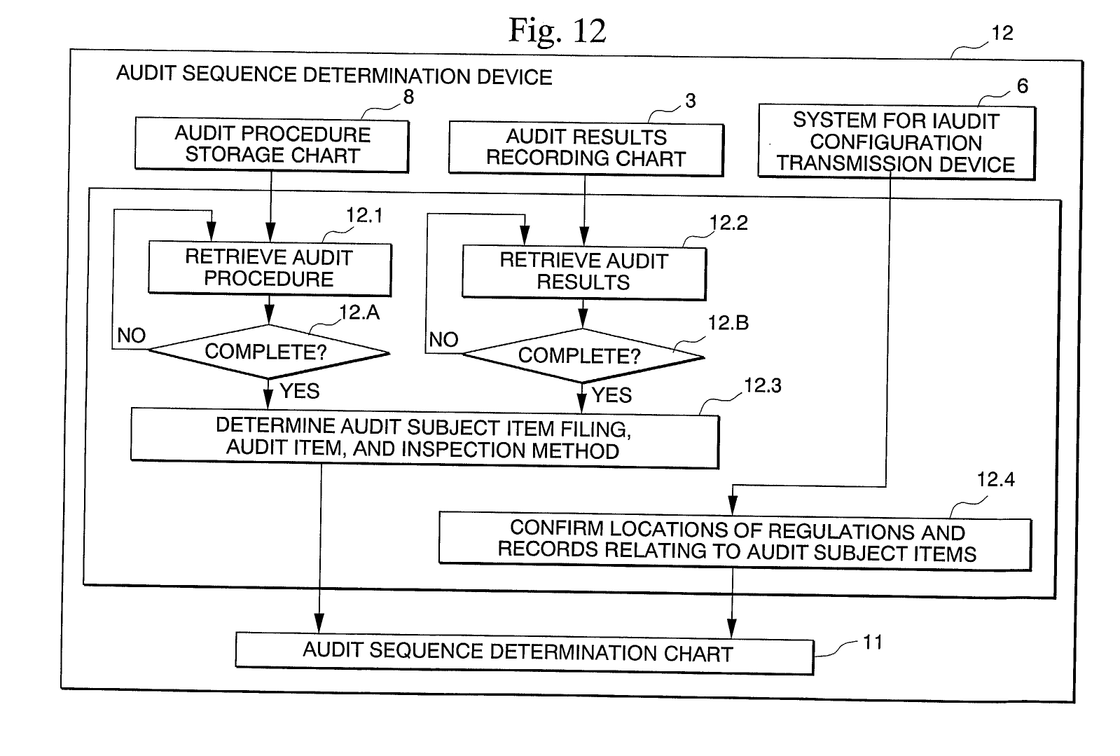

As shown in FIG. 12, the audit sequence determination device 12 determines the audit items, audit sequence and audit content for the current audit based on an audit procedure storage chart 8, the system for audit configuration transmission device 6 and the audit results recording chart 3.

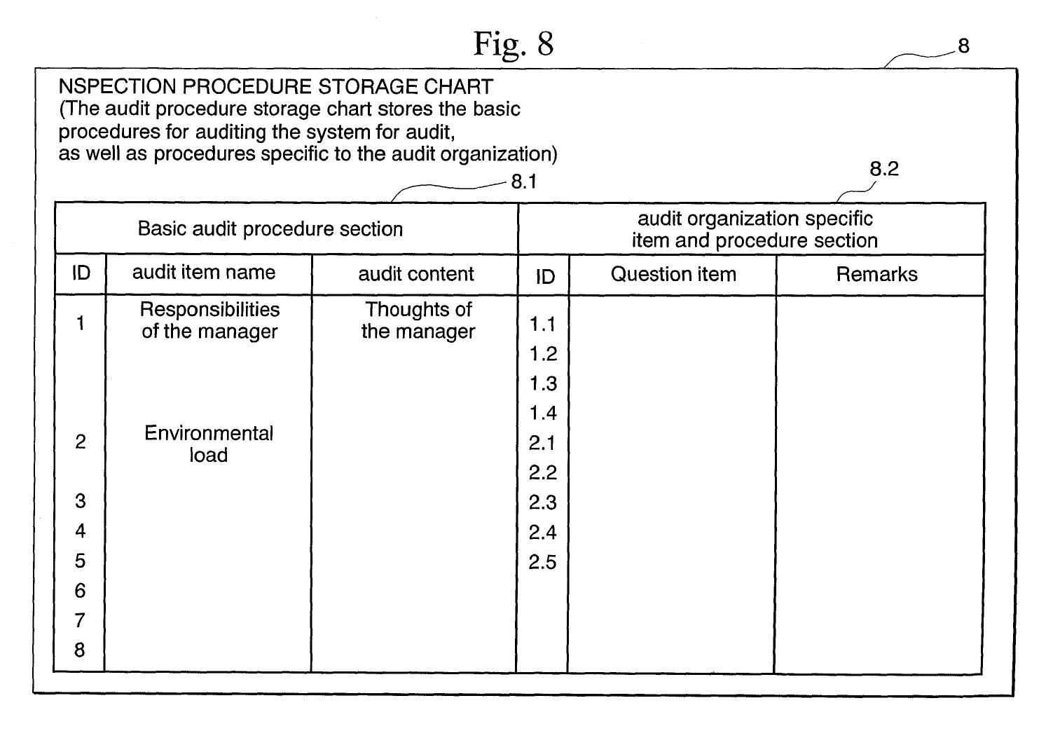

The audit procedure storage chart 8 (refer to FIG. 8) comprises a regulation basic audit procedure section 8.1 for managing the content of statutes, government orders, and specifications and the like for those audit items needed in performing an audit of the system for audit 4 (refer to FIG. 4), and an audit organization specific item and procedure section 8.2 for storing specific audit items and question content accumulated by the audit organization through experience.

FIG. 13 is a flowchart showing an embodiment of an electronic audit method of the present invention. As follows is a description of the operation of the electronic audit system described above, based on this flowchart. In order to be able to carry out an electronic audit, the system for audit must manage electronically an original of a regulation document and a procedure document defining the activity of a system. Furthermore, of the records recording the activity, the originals of records which can be managed electronically are managed as electronic data, whereas originals of records which are not suited to electronic management are managed on paper with only the management status being computerized.

In the management example, as shown in the system for audit regulation and record management section 4.3 (refer to FIG. 4), a chart is created which records an identifier for classifying the audit object (regulation or record), a document number identifying the audit object, a document name which makes it easy for a person to screen the content of the object from externally, the actual object entity itself (the content of the document) and an operation relating to the object (replace, delete, register). In the case of a product such as StarOffice (a product of N corporation which uses the concept of a computer based office with a desk, cabinets, folders and binders and the like to create a virtual office space), this chart can also be stored on a computer using the functions of the software such as offices, cabinets, folders and documents. Furthermore, the chart can also comprise a plurality of charts (step S0), depending on the size and scale of the system for audit.

In this manner, the maintenance and management of the electronic system is performed by the system for audit maintenance and management device 5 (refer to FIG. 5). The external environment (statutes, government orders, agreements, regulations and the like) changes frequently. As a result, the external environment recognition section 5.5 continually monitors the external environment for alterations. If an alteration occurs in the external environment (such as a revision of an agreement, for example), then the regulation update and creation section 5.6 finds the corresponding regulation and reflects the altered content in the existing “regulation”, and once approval is obtained, then replaces the “regulation” of the same document number in the chart of identifiers (regulations) managed by the system for audit regulation and record management section 4.3, with this newly edited document.

If a “regulation” with the same document number does not exist, then the document is added. Subsequently, the regulation, publication and notification section 5.7 notifies all those sections and departments, which need to be notified of regulation alterations and new publications of any such alterations or additions.

In contrast the activity plan recognition section 5.1 drafts a yearly activity plan based on the regulations. The activity content comprehension section 5.2 ascertains the content of the activity plan and drafts specific activity content. The activity execution section 5.3 performs the actual execution of the activity content specified by the activity content comprehension section 5.2.

The activity plan drafted by the activity plan recognition section 5.1, the activity content specified by the activity content comprehension section 5.2, and the content executed by the activity execution section 5.3 are recorded by the activity record creation and management section 5.4 in plan documents, minutes of meetings, reports, test documents and specification documents and the like, and are newly registered in the chart of identifiers (records) managed by the system for audit regulation and record management section 4.3 in those positions marked by the matching document numbers. At the time of registration, if a document with the same document number already exists, then a replacement is performed (step S1).

When an audit is performed on a system which is maintained and managed electronically in the manner described above, first information showing the configuration of the system for audit such as the information shown by the system for audit configuration transmission device 6 is transmitted to an audit sequence determination device 12 via a network or the like (step S2).

Next, the audit sequence determination device 12 functions in the manner shown in FIG. 12, and an audit procedure retrieval section 12.1 retrieves the basic audit procedure stored in the audit procedure storage chart 8 and the audit organization specific items and procedures, and an audit results retrieval section 12.2 retrieves the past audit results for the system being audited 4 stored in the audit results recording chart 3. An audit object item filing, and audit item and audit method determination section 12.3 determines the audit items, the audit content, and the audit type (distinguishing between whether the audit can be completed based solely on the records accumulated within the system for audit, or whether details need to be audited on site), and then creates the audit items, audit content and audit type for the audit sequence determination chart 11. Next, in order to clarify whereabouts within the system for audit 4 the audit objects (regulations, records and the like) corresponding with the audit items exist, an audit object item regulation and record location confirmation section 12.4 fills in the location items of the audit sequence determination chart 11 based on content transmitted from the system for audit configuration transmission device 6, thereby completing the audit sequence determination chart 11 showing the audit sequence for the system for audit 4 (step S3) Next, the audit is carried out based on the audit sequence determination chart 11, although before the audit starts, the connection with the system for audit 4 must be established. As a result, the preliminary audit section 2.1 accesses the system for audit 4 via the access establishment section 2.1.1 using the audit ID and password transmitted across the network or the like from the audit ID and password transmission device 7. The audit ID and password confirmation section 4.1 audits the content of the audit ID and password, and if valid, authorizes access (step S4).

The audit is then performed following the procedure described below. The audit device 2 comprises the preliminary audit section 2.1 and the site audit section 2.1, as shown in FIG. 2. The audit is conducted so that the preliminary audit of 2.1 precedes the site audit of 2.2. In the preliminary audit section 2.1, an audit sequence determination chart retrieval section 2.1.2 retrieves the content corresponding with item 001 from the items in the audit sequence of the audit sequence determination chart 11, judges whether or not the audit type is “Net”, and if the type is “Net”, then accesses the system for audit regulation and record management section 4.3 via an audit system access section 2.1.3 based on the location information of the audit object, and displays the corresponding content. The displayed content is compared with the audit content of the audit sequence determination chart 11, the validity verified (2.1.A) and the audit executed, and the audit results are then recorded in the audit results recording chart 3. This operation is then executed through to the final item of the audit sequence determination chart 11.

During the preliminary audit, regulations may require questions to be asked of the “manager”. Furthermore, if the content of any document or record is unclear, the content may need to be confirmed with the person responsible for the document or regulation. In such cases, by using a video conferencing or audio conferencing system, so that the audit proceeds with both parties able to view the record on screen, the quality and efficiency of the preliminary audit can be improved, and so the site audit is able to be conducted more effectively. In such conferences, it is important that both the auditor and the employee at the corporation undergoing audit are able to view the same content. Examples of suitable methods for ensuring this equal access to information include transmitting the “location” recorded in the audit sequence determination chart 11 to the other party, or verbally informing the other party of the audit object identifier or document number, either of which provides a simple method of enabling both parties to refer to the same document or record.

In the site audit section 2.2, an auditor travels to the site of the organization operating the system for audit 4, retrieves those items designated as site audit items within the audit type of the audit sequence determination chart 11, as well as those items designated for site audit during the preliminary audit of 2.1, and then conducts the audit through consultations with the necessary employees of the corporation. The audit results are recorded in the audit results recording chart 3 (step S5).

Next, the audit results for the audited system 4 from the current audit, as well as the results from past audits, are displayed using the audit results display device 9 (step S6).

The audit results judgement device 10 then judges the quality of the operating status of the audited system 4, using the processing flow shown in FIG. 10, based on the audit items, the audit content, and the audit results displayed chronologically for each audit item by the audit results display device 9. The results are recorded in the audit results recording chart 3 (step S7).

Subsequently, the results, explanations, and required processing generated as a result of the audit are sent to the organization operating the audited system 4 in electronic format (by email for example) or as hard copy, thereby completing the audit process. On receipt of the results, the organization operating the audited system 4 carries out the required improvements of the indicated items, and executes the processing of step S1, preparing for the next audit (step S8).

Generally, in those cases where the audit of the operating status of a system for audit is performed by a third party, the third party travels to the site, and then in response to questions from the third party conducting the audit, employees at the organization operating the system for audit retrieve and present those records in the system which are able to verify the content requested. The third party conducting the audit then performs the audit by checking the content of the presented records and judging their quality.

However, according to the present invention, the organization undergoing audit notifies the third party conducting the audit of the operating status of the system for audit, and provides the third party conducting the audit with an audit ID and password and configuration information for the system for audit, via an electronic device such as a network, so that the third part conducting the audit can access the system for audit directly, via an electronic device such as a network, without having to request the retrieval of each record from employees at the organization operating the system for audit. The third party is then able to view the necessary content of regulations and records. As a result, whereas conventionally an auditor needed to travel to the location of the organization operating the system for audit and conduct the audit of the operating status of the system from scratch, the present invention enables the auditor to use records to confirm the operating status of the system for audit before actually traveling to the audit site. Because the operating status of the system for audit can be confirmed in advance, the audit content of the site audit can be clarified in advance, resulting in improved audit content and a shorter audit period.

Furthermore, because the organization operating the system for audit also expends fewer employee work hours in dealing with the auditor during the site audit, efficiency improves. Furthermore, for the audit organization, because the ratio of auditors actually in-house improves, time can be assigned for the study of the latest audit techniques and technology. As a result, the organization undergoing audit receives a more precise audit, which improves customer satisfaction levels.

In those cases where an ISO 14001 compliant environment management system of N corporation is entirely computerized using the audit groupware and software of StarOffice, then when the appropriate certification authority JQA performs a periodic audit, the method of the present invention enables the audit to be performed efficiently from a remote location.

As described above, according to the present invention, an auditor can perform a preliminary audit of the system for audit without leaving the audit organization, thereby improving the audit efficiency. Because the auditor performs the preliminary audit in-house without leaving the audit organization, the ratio of auditors actually in-house improves, which enables the audit organization to conduct education sessions for improving factors such as the audit techniques of auditors, enabling an improvement in customer service. Furthermore, the customer (the corporation undergoing audit), is able to reduce the number of employee work hours required in dealing with the preliminary audit, as well as reduce the costs (such as travel costs and allowances) associated with the preliminary audit, and consequently receives a cheaper, yet higher quality audit. A electronic system for audit has many practical applications, and so the process of digitizing office work can be accelerated.

What is claimed is:

1. An electronic audit system comprising:
an electronic test object system;
an electronic audit system; and
a communication device for providing a line connection between said audit system and said test object system; wherein
said audit system and said test object system connect via said communication device, and said audit system audits said test object system based on necessary information sent from said test object system.

2. An electronic audit system comprising:
an electronic test object system;
an electronic audit system;
a maintenance management device for maintaining and managing said test object system;
a configuration transmission device for transmitting configuration information of said test object system to said audit system;
an identification information transmission device for transmitting an ID and a password to said audit system;
an audit sequence determination device for determining an audit sequence and creating a sequence chart showing said audit sequence;
an access device for accessing said test object system using an ID and a password received via said identification information transmission device;
an audit device for auditing said test object system accessed via said access device in accordance with said sequence chart and recording results;
a display device for displaying audit results obtained by audit with said audit device; and
a judgement device for judging quality of audit results based on said audit results displayed by said display device.

3. An electronic audit system according to claim 2, wherein an audit sequence determined by said audit sequence determination device incorporates a site audit performed by an auditor visiting said site.

4. An electronic audit system according to claim 2, wherein said judgement device judges operating status quality of said system for audit based on audit items, audit content and audit results displayed by said display device, and records such operating status quality in an audit results recording chart.

5. An electronic audit system according to claim 2, wherein within said test object system, an original of a regulation document and a procedure document defining system activity are managed electronically, and record documents for recording activity comprise records managed electronically and records managed on paper, and for records managed on paper, a management thereof is computerized.

6. An electronic audit system according to claim 2, wherein said maintenance management device monitors variations in external environment, and if a variation occurs, reflects such variation in said test object system.

7. An electronic audit method comprising the steps of:
constructing a system for audit;
maintaining and managing said system for audit;
receiving configuration information of said system for audit;
determining an audit sequence for said system for audit;
receiving an audit ID and password, and connecting to said system for audit; and
performing an audit of said system for audit in accordance with said determined audit sequence.

8. An electronic audit method according to claim 7, the method further comprises the step of:
displaying audit results for said system for audit; and
judging quality of audit results based on said displayed audit results.
